(19) United States
(12) Patent Application Publication
(10) Pub. No.: US 2010/0202941 A1
(43) Pub. Date: Aug. 12, 2010

(54) Liquid Fuel Reforming Device

(76) Inventor: Hideki Chikada, Kanagawa (JP)

Correspondence Address: IP Patent Docketing;K&L GATES LLP, 599 Lexington Avenue, 33rd Floor, New York, NY, 10022-6030, US

(21) Appl. No.: 11/571,333

(22) PCT Filed: Jul. 2, 2004
(86) PCT No.: PCT/JP04/09415

§ 371 Date: Dec. 27, 2006

(51) Int. Cl. F02M 27/02

(52) U.S. Cl. 422/240

(57) ABSTRACT

A liquid fuel reforming device is provided which, when an oil or other liquid fuel is passed therethrough, efficiently produces reformed liquid fuel by causing the liquid fuel to make contact with ceramic pieces loaded in the liquid fuel reforming device. The liquid fuel reforming device, which is installed in an oil supply line for reforming oil or other liquid fuel, comprises a main unit formed as a tubular body provided with connectors projecting from its opposite ends for connection with the supply line and having a diameter larger than the diameter of the supply line, liquid fuel entering the main unit being reformed therein and then discharged; at least one netlike body provided between the main unit and at least one of the connectors; and at least one ceramic piece loaded into the tubular main unit for electrically charging the liquid fuel.

### BACKGROUND OF THE INVENTION

1. Field of the Invention

The present invention relates to a device for reforming a fluid, particularly to a liquid fuel reforming device for reforming heavy fuel oil and other liquid fuels by bringing the liquid fuel into contact with a ceramic body to produce an action on its molecular association.

2. Description of Related Art

Recent years have seen the development of ceramic water reforming devices that claim to be effective for preventing red rust deterioration and removing scale in water supply lines, and test data verifying these effects have been published. However, such devices, most of which are said to utilize the action of far infrared radiation, remain suspect because the liquids they reform are in complete thermal equilibrium with no energy transfer at normal temperatures.

In addition, various activation devices have been developed and applied for patent. As an example can be cited the household water activation device taught by Japanese Laid-open Patent Application No. Hei 11-33541. The device set out in this application is equipped with a center ceramic body and a side ceramic body provided inside a large-diameter cylindrical body and adapted to promote activation by bringing divided water streams into contact with the ceramic bodies.

Moreover, Japanese Laid-open Patent Application No. 2000-107752 teaches a water activation device comprising a cylindrical body through which flowing water is passed and a ceramic disk provided with numerous passage pores and fins that is attached to a central shaft via a spacer, wherein the ceramic disk is rotated by the impact of the flowing water.

However, most of the conventional devices are water activation devices and a need has therefore remained for the development of a simply structured liquid fuel reforming device capable of readily reforming oil and other liquid fuels.

### SUMMARY OF THE INVENTION

An object of the present invention is therefore to meet this need by providing a liquid fuel reforming device for installation at a desired location in an oil or other liquid fuel supply line such that the flow of oil or other liquid fuel passing through the liquid fuel reforming device causes at least one ceramic piece installed inside the liquid fuel reforming device to oscillate, thereby effectively bringing the liquid fuel into contact with the ceramic piece or pieces to realize efficient reformation of the liquid fuel.

The invention achieves this object by providing a liquid fuel reforming device for installation in a liquid fuel supply line for reforming oil or other liquid fuel passed therethrough, which liquid fuel reforming device comprises:

a main unit formed as a tubular body provided with connectors projecting from its opposite ends for connection with the supply line and having a diameter larger than the diameter of the supply line, liquid fuel entering the main unit being reformed therein and then discharged;

at least one netlike body provided between the main unit and at least one of the connectors; and

at least one ceramic piece loaded into the tubular main unit for electrically charging the liquid fuel.

The main unit can be a tubular body made of stainless steel having a diameter larger than the diameter of the supply line and a total length of about 25 cm. The ceramic pieces can be cylindrical bodies having a radius of about 10-13 mm and a height of 15-20 mm, a plurality of which are loaded into the main unit.

The ceramic pieces can be constituted of kaolin and acid clay coated on the surface with metallic glaze and fired at a high temperature.

Owing to its configuration as set out in the foregoing, the liquid fuel reforming device according to this invention offers the following merits:

1. The liquid fuel reforming device of this invention enables supply of reformed oil and other liquid fuels with a device of simple structure comprising a main unit, at least one netlike member, and at least one ceramic piece. The simple structure of the device enhances durability and ease of maintenance. The configuration also facilitates replacement of the ceramic piece or pieces loaded in the main unit.
2. The liquid fuel reforming device can supply a reformed oil and other liquid fuel, thereby enabling enhanced combustion efficiency of the liquid fuel.
3. The number of ceramic pieces loaded into the main unit can be suitably adjusted to the optimum number for the properties of the liquid fuel to be reformed.
4. The provision of the netlike body or bodies inside the main unit prevents the ceramic pieces from passing into the supply line, thereby ensuring stable operation of the device.
5. Since the ceramic material used in the liquid fuel reforming device can be in the form of small ceramic pieces, the liquid fuel can be reformed by electrical charges produced by friction among the ceramic pieces and between the ceramic pieces and the liquid fuel.

### BRIEF DESCRIPTION OF THE DRAWINGS

FIG. 1 is a schematic diagram of the liquid fuel reforming device of the present invention.

FIG. 2(a) shows the carbon-13 NMR spectrum of a heavy fuel oil.

FIG. 2(b) is a graph showing the measured spin-lattice relaxation times of the main spectral peaks observed by carbon-13 nuclear magnetic resonance (NMR) analysis for the heavy fuel oil in the cases where the liquid fuel reforming device was used and not used.

FIG. 3 is table of measured results obtained when a heavy fuel oil-fired boiler was and was not equipped with the liquid fuel reforming device.

FIG. 4 is a table of measured results obtained when a heavy fuel oil-fired boiler was and was not equipped with the liquid fuel reforming device.

### DESCRIPTION OF THE PREFERRED EMBODIMENT

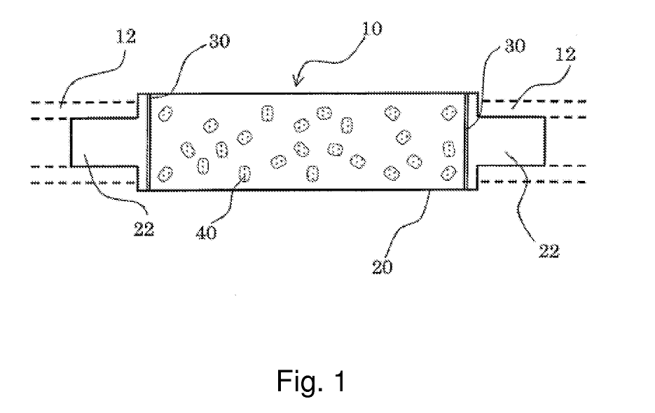

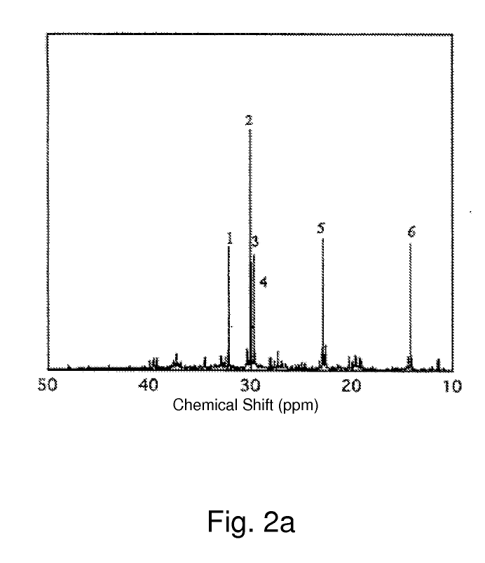

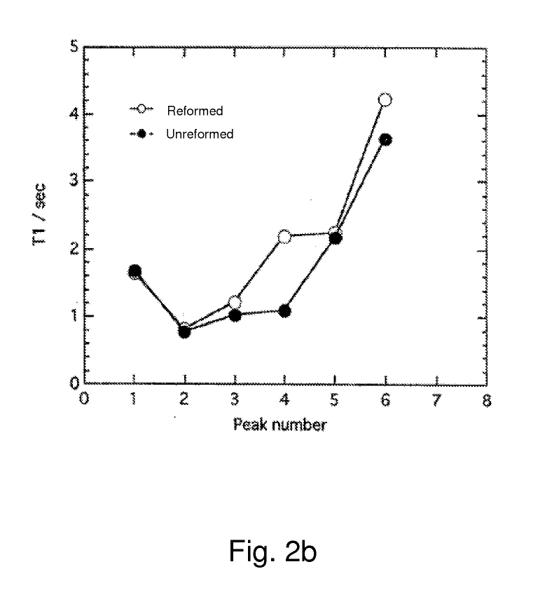

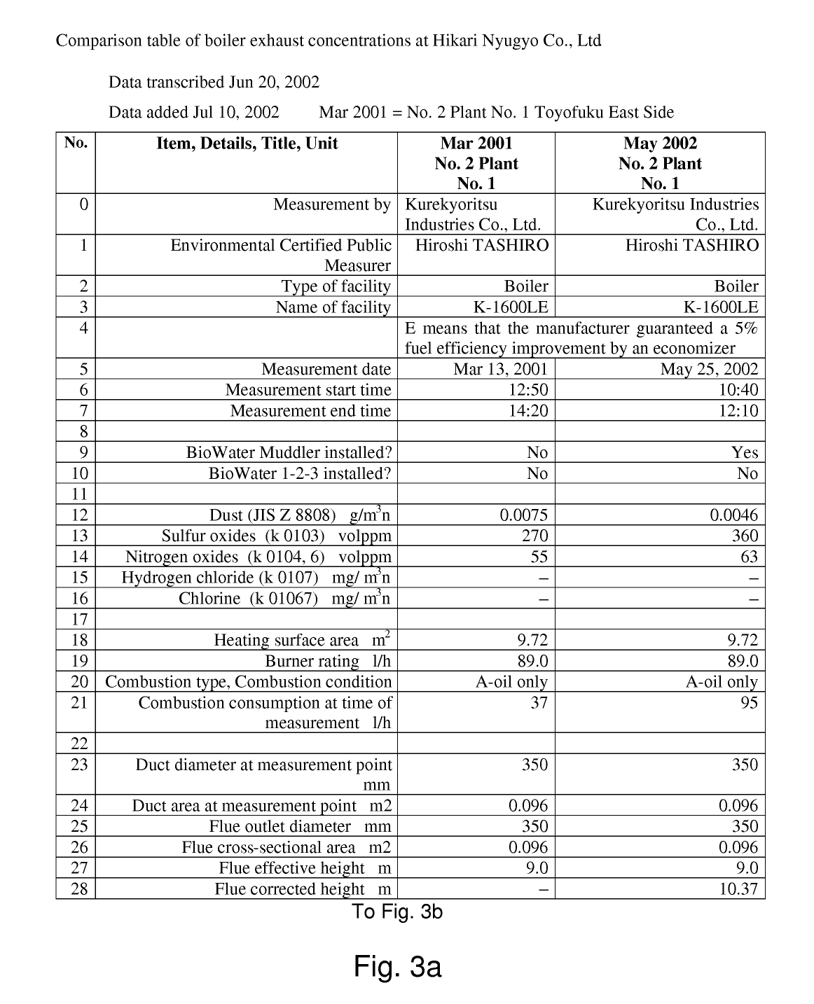

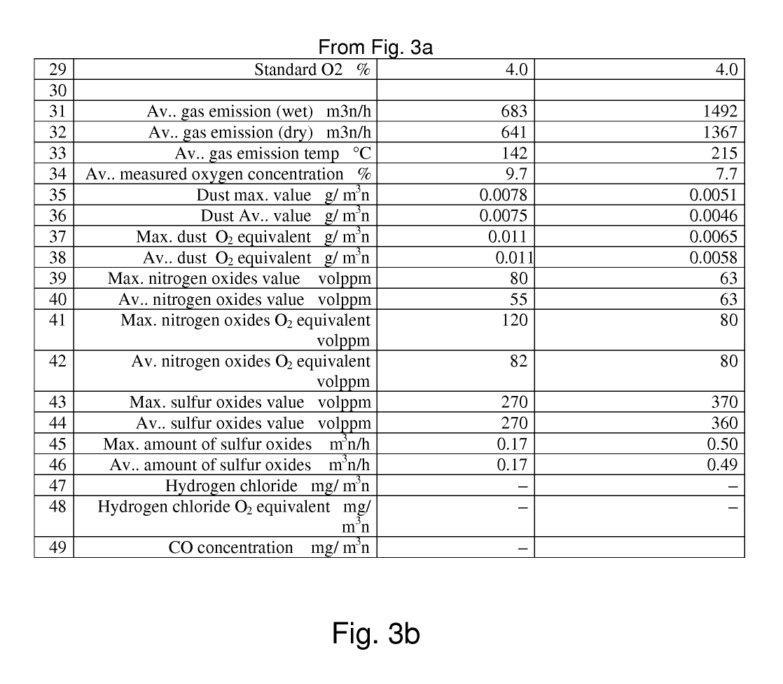

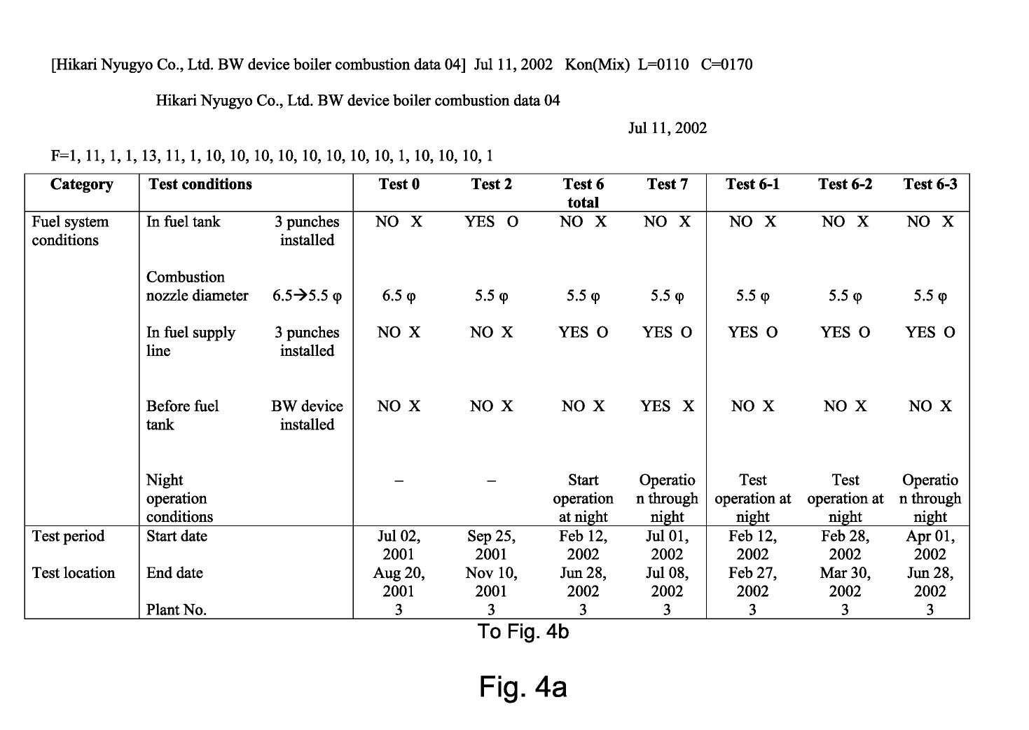

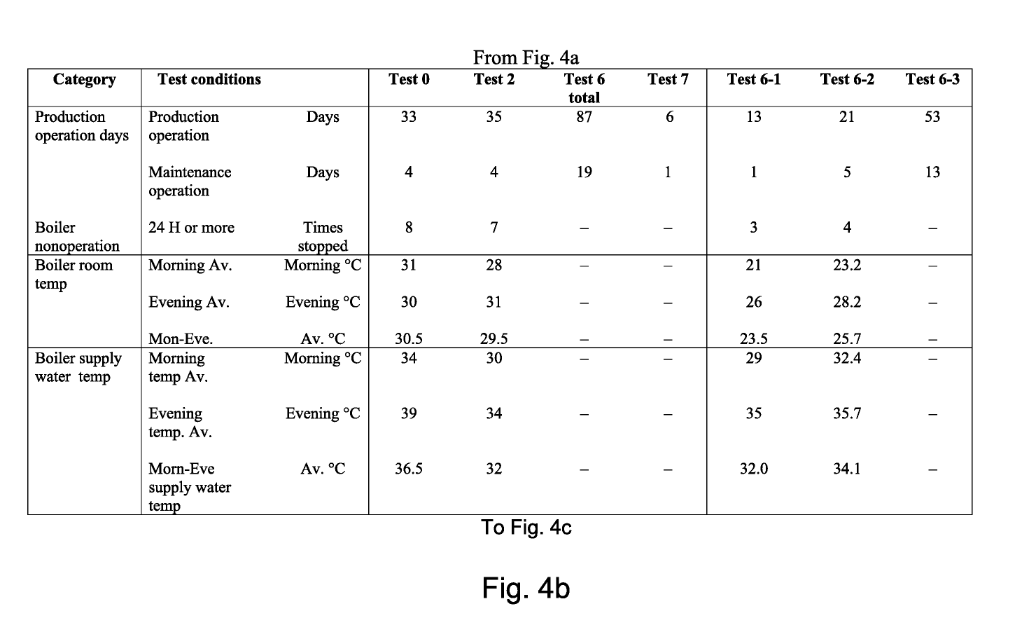

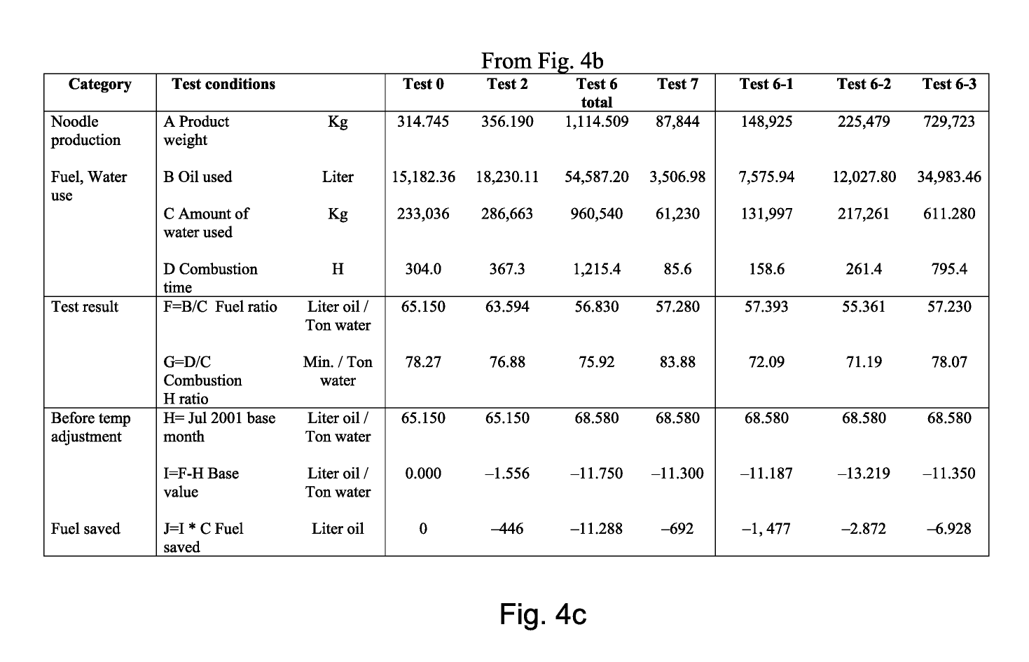

The liquid fuel reforming device according to the invention will now be explained in detail with reference to an embodiment shown in the drawings. FIG. 1 is a schematic diagram of the liquid fuel reforming device of the present invention. FIG. 2(a) shows the carbon-13 NMR spectrum of a heavy fuel oil. FIG. 2(b) is a graph showing the measured spin-lattice relaxation times of the main spectral peaks observed by carbon-13 nuclear magnetic resonance analysis for the heavy fuel oil in the cases where the liquid fuel reforming device was used and not used. FIGS. 3 and 4 are tables of measured results obtained when a heavy fuel oil-fired boiler was and was not equipped with the liquid fuel reforming device.

The liquid fuel reforming device of the invention, designated by the symbol 10 in the drawings, is composed of a tubular main unit 20, netlike bodies 30 and ceramic pieces 40.

The main unit 20 is equipped at its opposite ends with projecting connectors 22 for connection with a fuel supply line 12. An oil or other liquid fuel is fed into the main unit 20 from one end, reformed by modification of its liquid structure, and discharged from the other end of the main unit 20. The main unit 20 is a tubular body whose diameter is larger than the diameter of the fuel supply line 12. In the illustrated embodiment, the main unit 20 is a tubular body made of stainless steel. It is larger in diameter than the fuel supply line 12 and has an overall length of about 25 cm. Although the tubular main unit 20 can have any desired cross-sectional shape, including triangular and rectangular, it is preferably a circular cylinder because a cylindrical shape facilitates oscillation of the ceramic pieces 40 loaded therein. Further, replacement of the ceramic pieces 40 can be facilitated by providing the main unit 20 with a lid (not shown) or making at least one of its opposite ends detachable.

The netlike bodies 30 are mesh structures disposed between the main unit 20 and the connectors 22 at the opposite ends of the main unit 20. They serve as strainers for removing foreign matter contained in the liquid fuel passing through the liquid fuel reforming device and also prevent the ceramic pieces 40 from passing out of the main unit 20 into the fuel supply line 12. The shape of the netlike bodies 30 is preferably the same as the cross-sectional shape of the main unit 20. The mesh size thereof can be appropriately selected but must be decided so as not to allow passage of the ceramic pieces 40.

The ceramic pieces 40 loaded in the liquid fuel reforming device 10 are constituted of a blend of kaolin and acid clay that has been coated with metallic glaze and fired at a high temperature. The ceramic pieces 40 are not limited by shape. In this embodiment, they are cylindrical bodies having a radius of about 10-13 mm and a height of 15-20 mm. The number of the ceramic pieces 40 loaded into the main unit 20 is not particularly defined but is preferably greater than one. The number thereof can be suitably decided in accordance with the size of the main unit 20 and the properties of the liquid fuel. If the number of ceramic pieces is too large for the size of the main unit 20, the range of their oscillation in response to the flow of the liquid fuel may become so narrow as to make it impossible to sustain adequate contact with the liquid fuel or may result in blockage of the liquid fuel passage. If the number thereof is too small, the ceramic pieces cannot make contact with all of the liquid fuel. The number of ceramic pieces 40 loaded in the main unit 20 is therefore preferably decided taking these factors into account.

The manner of utilizing the liquid fuel reforming device 10 of the invention will now be explained in detail. The liquid fuel reforming device is installed in a fuel line by means of the connectors 22 so that the supplied oil or other liquid fuel passes through the liquid fuel reforming device 10 at least one time. When the liquid fuel flows through the liquid fuel reforming device 10, the ceramic pieces 40 present therein are entrained by the flow of liquid fuel to be oscillated and brought into thorough and even contact with the liquid fuel. The liquid fuel is therefore reformed as a result of being charged with static electricity. Owing to the provision of the netlike bodies 30 in the main unit 20, the ceramic pieces 40 continue oscillate inside the main unit 20 without passing to the outside, whereby the ceramic pieces 40 are electrically charged by friction among themselves and friction between the ceramic pieces 40 and the liquid fuel. The properties of the liquid fuel are modified upon making contact with the charged ceramic pieces 40, thereby reforming the liquid fuel by modifying its liquid structure.

FIG. 2(a) and FIG. 2(b) show a comparison between the data obtained for a fuel reformed using the liquid fuel reforming device and a fuel not reformed using the liquid fuel reforming device in testing carried out at the Kanagawa Industrial Technology Research Institute. Specifically, difference in the elongation of the relaxation times of the No. 3, 4 and 6 peaks appeared as a distinctive characteristic. This is considered to be because contact of the heavy fuel oil with the ceramic pieces 40 enabled the heavy fuel oil molecules to move more freely. More specifically, it is believed that the presence of absorbed oxygen and carbon dioxide gas and the like in the untreated heavy fuel oil causes the molecules of the oil to aggregate and slow the movement of the molecules. Since this enlarges the droplets of the spray at the time of combustion, the combustion efficiency is degraded. In the liquid fuel whose liquid structure has been reformed, on the other hand, the associative structure of the heavy fuel oil molecules is thought to have broken down owing to the static electric charge imparted by contact with the ceramic pieces 40. As a result, the aggregates disintegrate to enable freer movement of the heavy fuel oil molecules, whereby the droplets of the sprayed oil become finer, thereby increasing the combustion efficiency. The measurement results shown are in agreement with this analysis.

As can be seen from FIGS. 2(a) and 2(b), the carbon-13 NMR spectrum of the JIS (Japan Industrial Standard) Grade A oil used in the test indicates that the main component is probably a straight-chain unsaturated hydrocarbon with a carbon number of 16. Six main peaks were observed for the methylene group and methyl group in the main chain. The peaks Nos. 1 to 5 belong to methylene group and the peak No. 6 to methyl group. Focusing on these peaks, the inventors measured the carbon-13 NMR spin-lattice relaxation times T1 in order to examine the JIS Grade A oil that had been passed through the liquid fuel reforming device (the “reformed oil”) and the JIS Grade A oil that was not treated by passage through the liquid fuel reforming device (the “unreformed oil”). The results are shown in FIG. 2(b), from which it will be noted that the relaxation times differed at peaks Nos. 3, 4 and 6 indicated on the horizontal axis. Although no significant difference was observed between the reformed and unreformed heavy fuel oils near the middle region (peak Nos. 1 and 2) or at peak No. 5, the relaxation time of the reformed oil was elongated at peaks No. 3, 4 and 6. A long relaxation time indicates that time was needed for return to the original state. The reason for the elongation is considered to be that the contact of the heavy fuel oil with the ceramic pieces 40 facilitated movement of the oil molecules. The slow movement of the molecules of the unreformed heavy fuel oil is thought to be attributable to the fact that the molecules formed aggregates with the molecules of absorbed oxygen and carbon dioxide gas and the like. In the reformed heavy fuel oil, on the other hand, the aggregated state of the molecules is thought to have been broken down by electric charging resulting from contact with the ceramic pieces 40.

FIGS. 3 and 4 are tables showing a comparison between the measured results obtained when the liquid fuel reforming device of this invention was installed in a heavy fuel oil supply line and the measured results obtained when the liquid fuel reforming device was not installed. On the left side of FIG. 3 are shown the results of measurements taken in March 2001 without use (installation) of the liquid fuel reforming device. On the right side are shown the results of measurements taken in May 2002 with use of the liquid fuel reforming device. Whether or not the liquid fuel reforming device was used is indicated by the presence/absence of an installed BioWater Muddler denoted as the device at Item No. 9 on the left side of FIG. 3. What was learned from these measurement results is that, as indicated at No. 34 (average measured oxygen concentration) and Nos. 35 and 36 (maximum dust value and average dust value), the average measured oxygen concentration in the run with the invention device installed was between 9.7 and 7.7 and the maximum and average dust values decreased. These low numerical values mean that the combustion efficiency improved owing to contact of the liquid fuel with the ceramic pieces 40. In addition, the decrease in the low maximum and average dust values shows that when the liquid fuel reforming device was installed, the heavy fuel oil was reformed by contact with the ceramic pieces 40, thereby enhancing the combustion efficiency.

FIG. 4 shows the measured results in a fuel system test conducted under closely defined test conditions. In this table of measurement results, the “punch” test condition among the fuel system conditions refers to the ceramic pieces 40. In Test 6 carried out under these measurement conditions, the liquid fuel reforming device of the invention was used. The main point demonstrated by the measurement results in FIG. 4 is the large difference between Test 6 and the other tests shown in the fuel economy item at the bottom of the table. In other words, the measured results prove that a marked improvement in combustion efficiency is achieved when the liquid fuel reforming device of the invention is utilized.

Although the liquid fuel reforming device of the invention is explained in the foregoing with focus on reformation of a liquid fuel, setting out measurement results for an embodiment applied particularly to reformation of heavy fuel oil, a similar reformation effect can also be anticipated in the case of other liquid fuels in general.

That is to say, the invention makes it possible to achieve reformation of other oils and the like by retrofitting a device of simple structure.

The ceramic pieces used in the foregoing embodiment are composed of a ceramic constituted mainly of a blend of kaolin and acid clay that has been surface-coated with metallic glaze and fired at a high temperature. However, the ceramic pieces are not limited to this composition and it is possible to charge into the invention device and use ceramic pieces of any composition that is capable of electrically charging a fuel oil on contact therewith.

What is claimed is:

1. A liquid fuel reforming device for installation in a liquid fuel supply line for reforming oil or other liquid fuel passed therethrough, which liquid fuel reforming device comprises:
a main unit formed as a tubular body provided with connectors projecting from its opposite ends for connection with the supply line and having a diameter larger than the diameter of the supply line, liquid fuel entering the main unit being reformed therein and then discharged;
at least one netlike body provided between the main unit and at least one of the connectors; and
at least one ceramic piece loaded into the tubular main unit for electrically charging the liquid fuel.

2. The liquid fuel reforming device according to claim 1, wherein the tubular body is made of stainless steel to have a diameter larger than the diameter of the supply line and a total length of about 25 cm.

3. The liquid fuel reforming device according to claim 1, wherein the at least one ceramic piece is a cylindrical body having a radius of about 10-13 mm and a height of 15-20 mm.

4. A liquid fuel reforming device according to claim 1, wherein a plurality of the ceramic pieces are loaded into the main unit.

5. A liquid fuel reforming device according to claim 1, wherein the at least one ceramic piece is constituted of kaolin and acid clay coated on the surface with metallic glaze and fired at a high temperature.
